(19) United States
(12) Patent Application Publication
(10) Pub. No.: US 2025/0228371 A1
(43) Pub. Date: Jul. 17, 2025

(54) ARMREST

(71) Applicant: TOYOTA BOSHOKU KABUSHIKI KAISHA, Aichi-ken (JP)

(72) Inventor: Shinji KAMIYA, Aichi-ken (JP)

(73) Assignee: TOYOTA BOSHOKU KABUSHIKI KAISHA, Aichi-ken (JP)

(21) Appl. No.: 19/020,297

(22) Filed: Jan. 14, 2025

(30) Foreign Application Priority Data
Jan. 17, 2024 (JP) 2024-005018

(51) Int. Cl. A47C 7/74; A47C 7/54

(52) U.S. Cl. CPC A47C 7/748; A47C 7/54

(57) ABSTRACT

An armrest having an elbow rest surface includes an armrest base material forming a framework along the elbow rest surface, a cushioning armrest pad provided on a base material surface of the armrest base material, and an armrest cover covering the armrest pad from a pad front side. The armrest base material includes a base material top plate extending along the elbow rest surface, a bent-down portion bent downward from an end of the base material top plate, and a base material bulging portion bulging from an end of a bent tip of the bent-down portion toward a base material front side. The armrest pad is provided across the base material top plate and the bent-down portion to form a surface shape continuous with the base material bulging portion. The armrest cover is covered across the armrest pad and the base material bulging portion.

### CROSS-REFERENCE TO RELATED APPLICATIONS

This application is based on and claims priority under 35 USC 119 from Japanese Patent Application No. 2024-005018 filed on Jan. 17, 2024, the entire content of which is incorporated herein by reference.

### TECHNICAL FIELD

The present disclosure relates to an armrest. Specifically, the present disclosure relates to an armrest having an elbow rest surface.

### BACKGROUND ART

JP2023-072309A discloses an armrest provided on a side portion of a vehicle seat. The armrest includes an armrest base material made of resin, an armrest pad made of urethane foam and provided on the surface of the armrest base material, and an armrest cover covering the armrest pad from the front side.

In the configuration described in JP2023-072309A, the armrest pad extends to the rear edge of the armrest. Therefore, a pressing force due to the stretching of the armrest cover is likely to concentrate on the rear upper edge of the armrest pad, and a highlight line, which is a cause of deterioration in appearance, is likely to appear on the cover surface. Accordingly, the present disclosure provides an armrest in which the shape of the cover surface is unlikely to collapse.

### SUMMARY OF INVENTION

An armrest according to the present disclosure is configured as follows.

According to a first aspect of the present disclosure, an armrest having an elbow rest surface includes an armrest base material forming a framework along the elbow rest surface, a cushioning armrest pad provided on a base material surface of the armrest base material, and an armrest cover covering the armrest pad from a pad front side. The armrest base material includes a base material top plate extending in an armrest front-rear direction along the elbow rest surface, a bent-down portion bent downward from an end of the base material top plate in the armrest front-rear direction, and a base material bulging portion bulging from an end of a bent tip of the bent-down portion toward a base material front side. The armrest pad is provided across the base material top plate and the bent-down portion. The base material bulging portion bilges such that a surface of the base material bulging portion forms a surface shape continuous with the armrest pad. The armrest cover is covered across the armrest pad and the base material bulging portion.

According to the first aspect of the present disclosure, the armrest pad is bent across the base material top plate and the bent-down portion of the armrest base material. Further, the end facing the base material bulging portion of the armrest pad is arranged to form a surface shape continuous with the base material bulging portion. Accordingly, the pressing force due to the stretching of the armrest cover is strongly applied to the R-shaped portion of the armrest pad, and thus is less likely to concentrate on the upper edge of the end. As a result, a highlight line, which is a cause of deterioration in appearance, is less likely to appear on the cover surface, and the shape of the cover surface is less likely to collapse.

According to a second aspect of the present disclosure, the armrest according to the first aspect, further includes a planar heater base fabric including a heating wire, the heater base fabric being sandwiched between the armrest pad and the armrest cover. The heater base fabric has a first sticking portion passed between the base material bulging portion and the armrest cover and sticking to the base material bulging portion.

According to the second aspect, the heater base fabric sticks to the base material bulging portion, thereby preventing the heater base fabric from being pulled out to the front side by the repulsive force of the armrest pad.

According to a third aspect of the present disclosure, the armrest according to the second aspect, in which the bent-down portion is bent downward from a rear end of the base material top plate. The heater base fabric further includes a second sticking portion passed through the base material back side and sticking to the armrest base material to wrap a front end of the base material top plate.

According to the third aspect, the front and rear portions of the heater base fabric across the armrest pad stick to the armrest base material. This can more appropriately prevent the heater base fabric from being pulled out to the front side by the repulsive force of the armrest pad.

According to a fourth aspect of the present disclosure, the armrest according to the first aspect, in which the base material bulging portion is provided at a position lower than the base material top plate.

According to the fourth disclosure, even when a load is applied to the vicinity of the bent-down portion from above due to an elbow resting thereon, the upper corner of the end facing the armrest pad of the base material bulging portion is less likely to come into contact with the elbow. This can reduce the foreign object sensation during use of the armrest. In addition, if a wiring such as a heating wire is passed through the upper corner of the base material bulging portion, a load applied to the wiring during use can be reduced.

According to a fifth aspect of the present disclosure, the armrest according to second aspect, in which the heating wire includes a slack portion bent to form a slack along a planar direction of the heater base fabric in a region across the armrest pad and the base material bulging portion.

According to the fifth aspect, it is possible to prevent the heating wire from tightening when a load is applied to the elbow rest surface from above due to an elbow resting thereon. This can prevent an excessive load from being applied to the heating wire such that the heating wire is strongly pressed against the upper corner of the base material bulging portion.

### BRIEF DESCRIPTION OF DRAWINGS

FIG. 1 is a perspective view illustrating a schematic configuration of an armrest according to a first embodiment;

FIG. 2 is an exploded perspective view of the armrest with an armrest cover removed;

FIG. 3 is an exploded perspective view of the armrest with a heater base fabric further removed;

FIG. 4 is an exploded perspective view of the armrest with an armrest pad further removed;

FIG. 5 is a longitudinal cross-sectional view of the armrest taken along a vertical plane passing through the vicinity of the center thereof;

FIG. 6 is a perspective view of the armrest as viewed from the back side;

FIG. 7 is a plan view of the heater base fabric alone;

FIG. 8 is an enlarged view of a portion VIII in FIG. 5;

FIG. 9 is a back view of the rear end of the armrest as viewed in the direction of an arrow IX in FIG. 8; and

FIG. 10 is an enlarged view of a portion X in FIG. 5.

### DESCRIPTION OF EMBODIMENTS

Hereinafter, an embodiment of the present disclosure will be described with reference to the drawings.

### First Embodiment

### <General Configuration of Armrest 1>

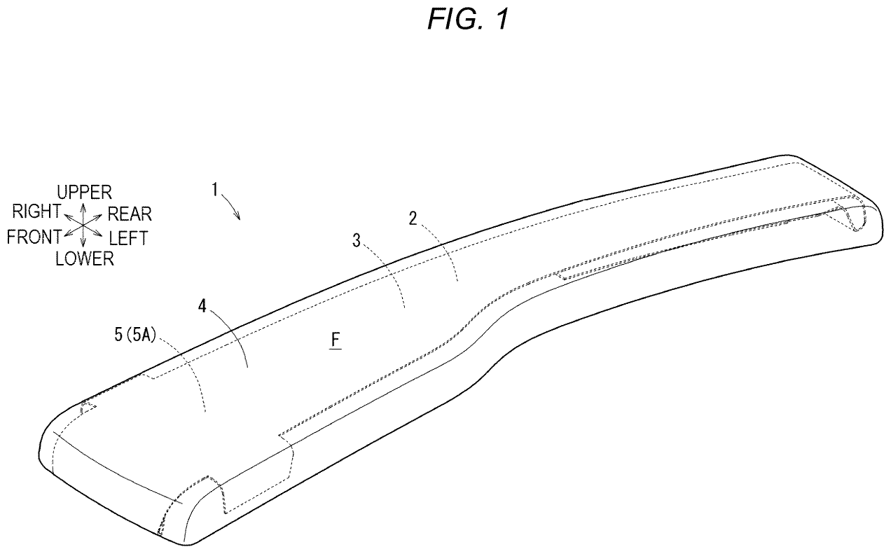

First, a configuration of an armrest 1 according to a first embodiment of the present disclosure will be described with reference to FIGS. 1 to 10. In the following description, when a direction such as front, rear, upper, lower, left, or right is described, it is assumed that the direction indicates a corresponding direction illustrated in the drawings. In addition, in the following description, when a specific reference diagram is not described or when there is no corresponding reference numeral in the reference diagram, any one of FIGS. 1 to 10 is referred to as appropriate.

As illustrated in FIG. 1, an armrest 1 according to the present embodiment is configured as a so-called door armrest to be attached to a door trim on the right side of an automobile (not illustrated). The armrest 1 includes an elbow rest surface F extending in a shape elongate in the front-rear direction (the armrest front-rear direction) along the door trim. The armrest 1 is configured to be suitably used as an elbow rest of the right elbow of a person seated in the seat (not illustrated) adjacent to the door trim.

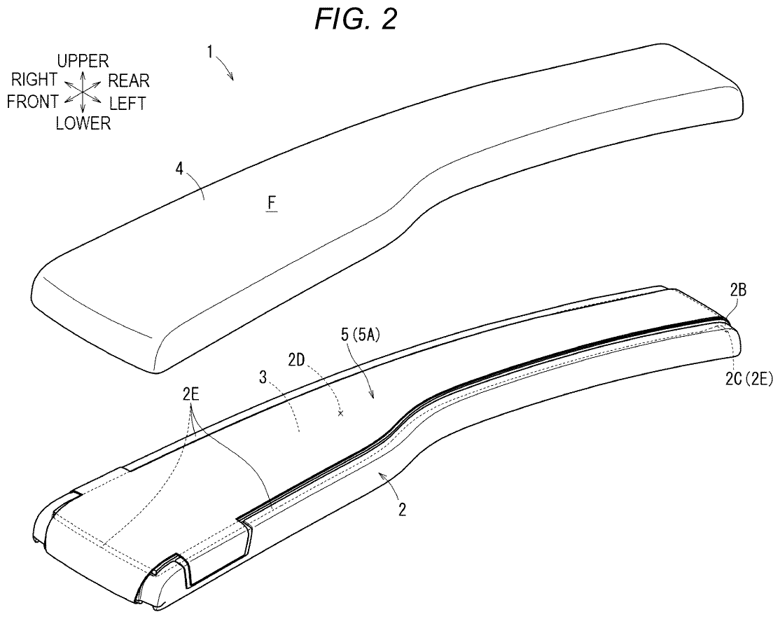

As illustrated in FIG. 2, specifically, the armrest 1 includes an armrest base material 2 made of resin and attached to the door trim (not illustrated), and an armrest pad 3 made of foamed urethane and provided on a base material surface (the illustrated upper surface) of the armrest base material 2. The armrest 1 includes an armrest cover 4 made of synthetic leather and covering the armrest pad 3 from the pad front side, and a planar heater base fabric 5 sandwiched between the armrest pad 3 and the armrest cover 4.

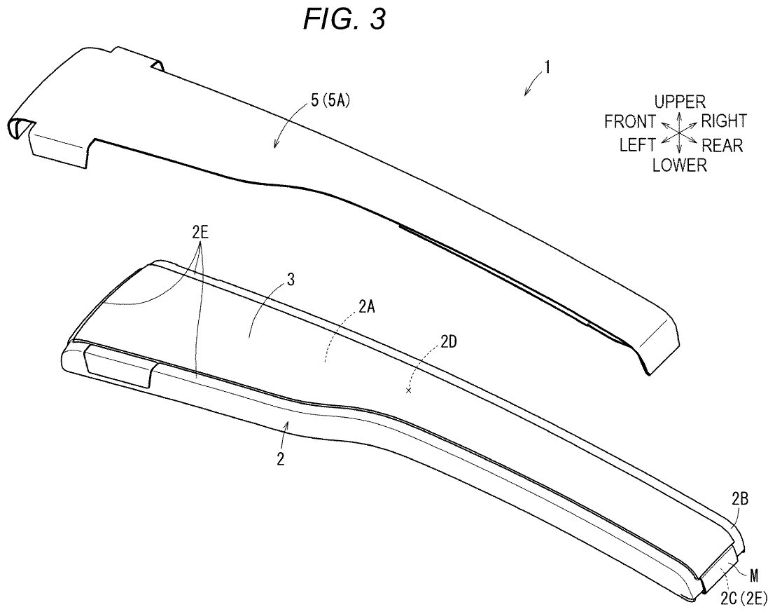

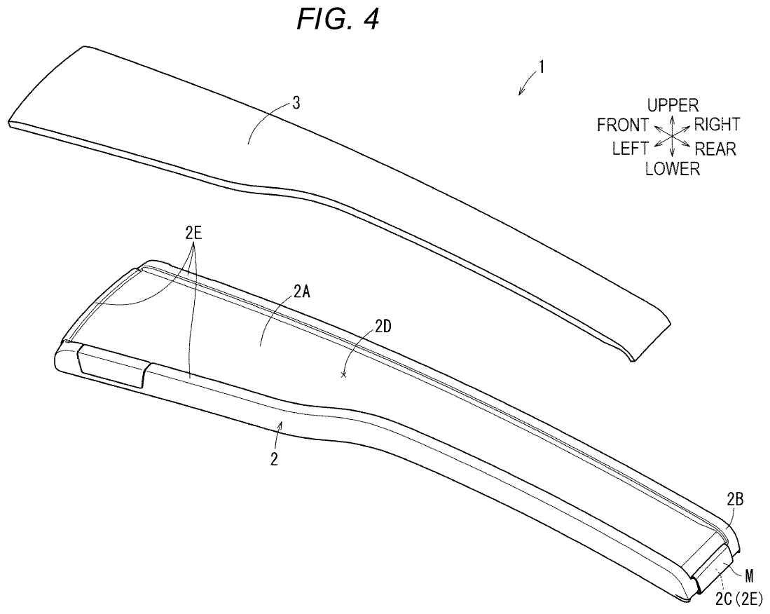

As illustrated in FIGS. 3 and 4, the armrest base material 2 has a flat plate-shaped base material top plate 2A extending in the front-rear direction along the elbow rest surface F (see FIG. 1). In addition, the armrest base material 2 has a bent-down portion 2B extending while being curved downward from the rear end of the base material top plate 2A. In addition, the armrest base material 2 has a base material bulging portion 2C bulging from the end of the bent tip of the bent-down portion 2B toward the base material front side. The base material bulging portion 2C has a felt M integrally adhered in a manner wrapping from the rear side across the front and rear surfaces thereof.

In addition, in the armrest base material 2, an upper surface region across the base material top plate 2A and the bent-down portion 2B is provided with a recessed pad accommodating recess 2D capable of accommodating the armrest pad 3 in a manner of being fitted from above. Accordingly, the peripheral edge of the upper surface region across the base material top plate 2A and the bent-down portion 2B is provided with an edge 2E that rises to surround the pad accommodating recess 2D.

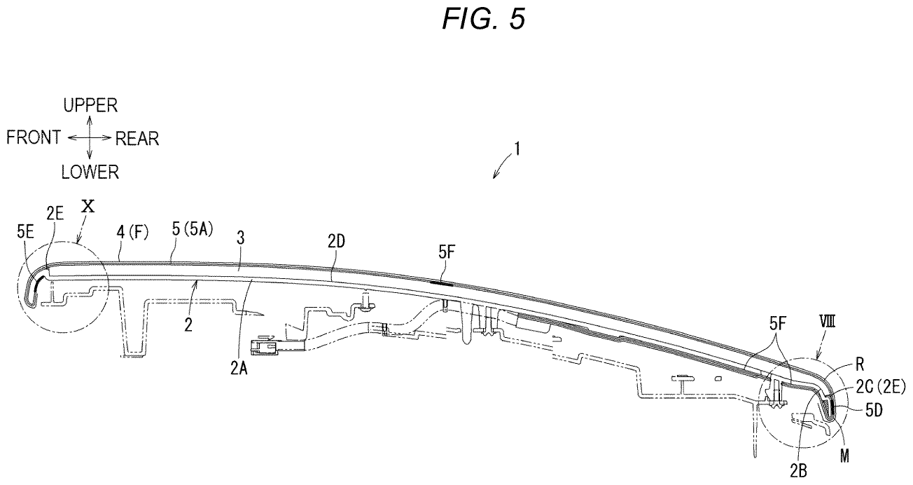

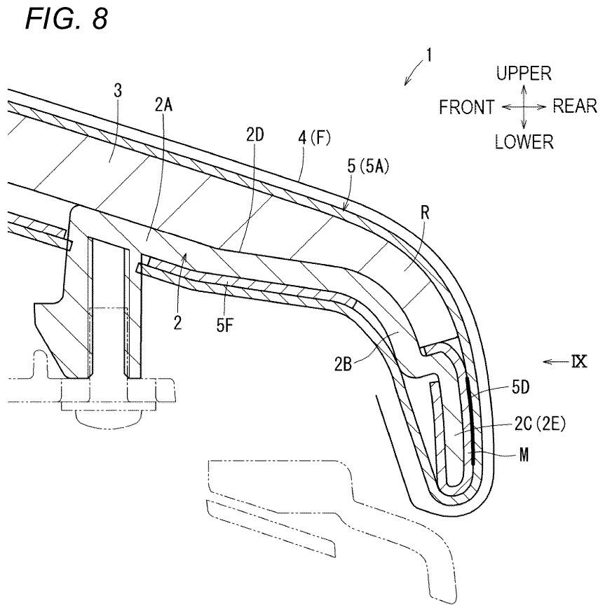

The above-described base material bulging portion 2C is formed to also serve as one side (rear side) of the edge 2E. The base material bulging portion 2C bulges such that its surface forms a surface shape continuous with the armrest pad 3. As illustrated in FIGS. 5 and 8, the base material bulging portion 2C is configured such that the surface thereof is also covered by the armrest cover 4 covering the pad surface of the armrest pad 3, thereby functioning to shape the surface shape of the rear end of the armrest 1.

As illustrated in FIGS. 3 and 4, the armrest pad 3 is made of rectangular plate-like slab urethane cut in accordance with the shape of the pad accommodating recess 2D. The armrest pad 3 has a pad thickness that protrudes slightly higher than the edge 2E around the armrest pad 3 when fitted into the pad accommodating recess 2D.

As illustrated in FIGS. 5 and 8, the armrest pad 3 has the armrest cover 4 stretched on the pad surface thereof, and thus is pushed and contracted by the tension to have substantially the same height as the edge 2E and the base material bulging portion 2C of the armrest base material 2. Accordingly, the armrest pad 3 and the edge 2E including the base material bulging portion 2C of the armrest base material 2 form a flush inner surface that shapes the surface shape of the armrest 1.

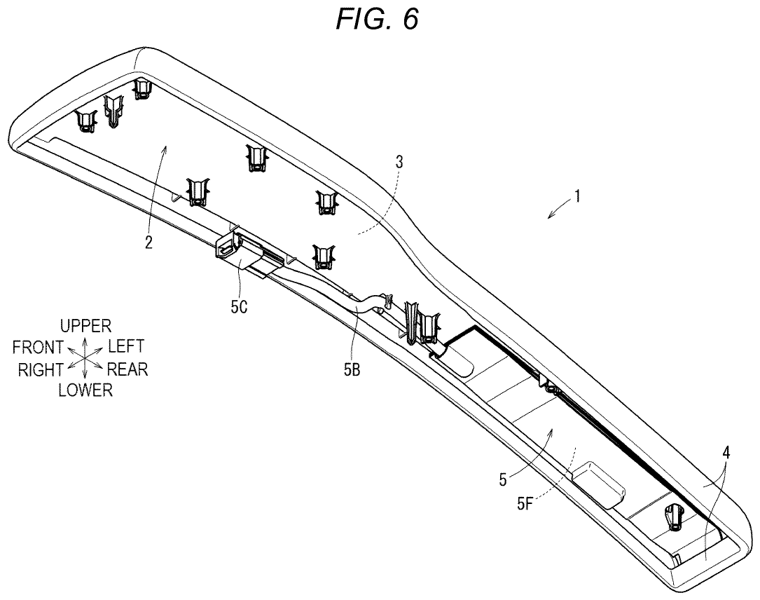

The armrest cover 4 covers the armrest pad 3 from the pad front side (upper side in the drawing). The armrest cover 4 is fixed by drawing the front, rear, left, and right peripheral edges of the armrest cover 4 covered by the armrest cover 4 to the base material back side of the armrest base material 2 (see FIG. 6). Accordingly, the armrest cover 4 is stretched to widely adhere to the pad surface of the armrest pad 3 and the edge 2E including the base material bulging portion 2C of the armrest base material 2 (see FIG. 5).

As illustrated in FIGS. 5 and 8, specifically, the armrest cover 4 is provided such that the armrest pad 3 is bent across the base material top plate 2A and the bent-down portion 2B of the armrest base material 2. Therefore, the pressing force due to the stretching is less likely to concentrate on the upper edge of the rear end of the armrest pad 3. The reason is that, due to the bending of the armrest pad 3, the portion forming the upper edge shape of the rear end of the armrest 1 is formed not by the rear end of the armrest pad 3 but by the bent R-shaped portion R.

As a result, the pressing force due to the stretching of the armrest cover 4 is applied to the R-shaped portion R without concentrating on the rear end of the armrest pad 3. As a result, a highlight line, which is a cause of deterioration in appearance, is less likely to appear on the cover surface of the armrest cover 4, and the shape of the cover surface is less likely to collapse.

As illustrated in FIG. 2, the heater base fabric 5 is laid on the pad surface of the armrest pad 3. As illustrated in FIG. 5, the armrest cover 4 is stretched to cover the armrest pad 3 from the pad front side, so that the heater base fabric 5 is sandwiched between the armrest pad 3 and the armrest cover 4 in a stacked manner.

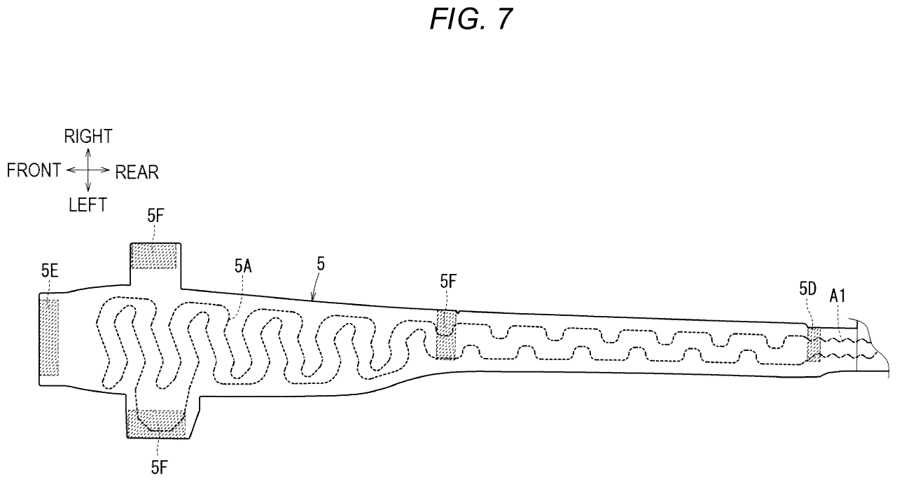

The heater base fabric 5 is formed of a planar member made of an extensible nonwoven fabric. As illustrated in FIG. 7, a heating wire 5A is sewn to the lower surface of the heater base fabric 5 to be laid widely. The heating wire 5A is routed to extend in the front-rear direction while being repeatedly bent in a wavy shape in the left-right direction (armrest width direction) along the lower surface of the heater base fabric 5. Accordingly, as illustrated in FIG. 2, heat is applied over a wide range of the elbow rest surface F of the armrest 1.

The heating wire 5A is also set in a region covering the left side surface of the front end of the armrest base material 2 of the heater base fabric 5. Accordingly, when the seated person places the right elbow on the elbow rest surface F of the armrest 1 and expands the right hand to grasp the armrest 1 with the hand, heat is also applied to the left side surface portion on which the thumb is placed.

As illustrated in FIG. 3, the heating wire 5A is also set in a region laid on the surface of the base material bulging portion 2C of the heater base fabric 5. Accordingly, in addition to elbow rest surface F of armrest 1, heat is also applied to the rear surface of armrest 1 facing the rear side.

As illustrated in FIG. 2, the heater base fabric 5 is covered from the front side across the armrest pad 3 and the edge 2E of the armrest base material 2 around the armrest pad 3. Specifically, as illustrated in FIG. 8, the heater base fabric 5 extends from the armrest pad 3 toward the rear side and also covers the surface of the base material bulging portion 2C forming the edge 2E on the rear side of the armrest base material 2.

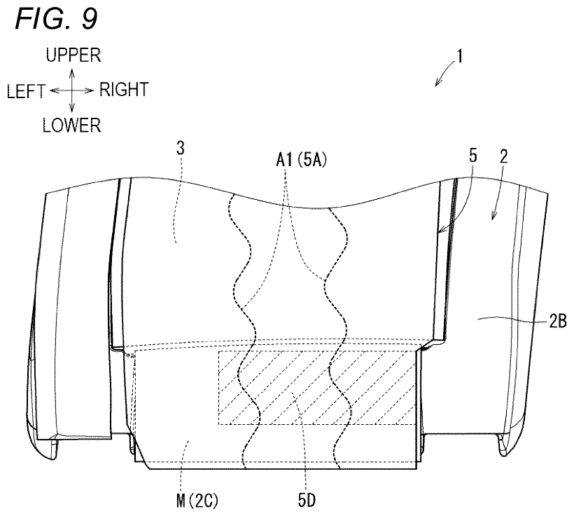

The portion of the heater base fabric 5 covering the surface of the base material bulging portion 2C sticks to (the felt M adhering to) the base material surface of the base material bulging portion 2C by a first sticking portion 5D made from double-sided tape (see FIG. 9). Further, the heater base fabric 5 is drawn to the base material back side of the armrest base material 2 and sticks to the base material back side by another sticking portion 5F made from double-sided tape to wrap the base material bulging portion 2C together with the felt M from the rear side.

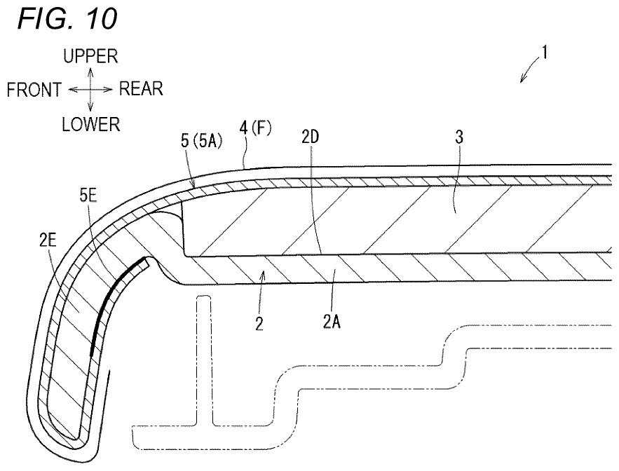

As illustrated in FIG. 10, the heater base fabric 5 extends from the armrest pad 3 toward the front side and also covers the front side surface of the edge 2E on the front side of the armrest base material 2. The heater base fabric 5 is drawn to the base material back side of the armrest base material 2 and sticks to the base material back side of the armrest base material 2 by a second sticking portion 5E made from double-sided tape to wrap the edge 2E of the armrest base material 2 on the front side from the front side.

As illustrated in FIG. 2, the heater base fabric 5 further extends from the front portion of the armrest pad 3 toward the left and right sides, and also covers the left side surface of the left edge 2E and the right side surface of the right edge 2E of the armrest base material 2. The portions of the heater base fabric 5 covering the left and right side surfaces of the armrest base material 2 stick to the side surfaces by another sticking portion 5F made from double-sided tape (see FIG. 7).

As illustrated in FIG. 5, the substantially central portion of the region covering the pad surface of the armrest pad 3 of the heater base fabric 5 sticks to the pad surface by another sticking portion 5F made from double-sided tape. Due to such sticking, the heater base fabric extends along the surface shapes of the armrest pad 3 and the armrest base material 2.

Specifically, the heater base fabric 5 sticks not only to the armrest pad 3 but also to the base material bulging portion 2C and the edge 2E on the front side of the armrest base material 2, which are located at a position beyond the armrest pad 3 in the front-rear direction. For this reason, even when the heater base fabric 5 receives a repulsive force from the armrest pad 3, the heater base fabric 5 is strongly supported by the base material bulging portion 2C and the edge 2E on the front side of the armrest base material 2, and is not pulled out to the front side (upper side in the drawing).

That is, when the heater base fabric 5 temporarily sticks only to the armrest pad 3, the heater base fabric 5 may be pulled out to the front side by the repulsive force of the armrest pad 3. However, the heater base fabric 5 sticks to the base material bulging portion 2C or the edge 2E of the armrest base material 2 on the front side, which are located at a position beyond the armrest pad 3 in the front-rear direction, and thus is appropriately prevented from being drawn out due to the repulsive force.

As illustrated in FIG. 9, the heating wire 5A sewn to the heater base fabric 5 has a shape including a slack portion A1 extending in the upper-lower direction while being bent in a zigzag shape in the left-right direction, which is the planar direction of the heater base fabric 5, in a region across the armrest pad 3 and the base material bulging portion 2C. With such a configuration, the heating wire 5A is less likely to tighten even when a load is applied to the elbow rest surface F (see FIG. 8) from above due to an elbow resting thereon. FIG. 9 is a diagram in which the armrest cover 4 is omitted.

Accordingly, the heating wire 5A is less likely to be subjected to an excessive load so as to be strongly pressed against the upper corner of the base material bulging portion 2C. That is, when a load from above is applied to the elbow rest surface F (refer to FIG. 8), the heating wire 5A is bent to stretch the slack of the slack portion A1 thereof in the upper-lower direction due to the bending due to the stretching of the heater base fabric 5. Accordingly, due to such flexibility, the heating wire 5A is less likely to tighten so as to be strongly pressed against the upper corner of the base material bulging portion 2C.

As illustrated in FIG. 8, the base material bulging portion 2C is provided at a position lower than the base material top plate 2A. Therefore, even when a load is applied to the vicinity of the bent-down portion 2B from above due to an elbow resting thereon, the upper corner facing the armrest pad 3 of the base material bulging portion 2C is less likely to come into contact with the elbow. This can reduce the foreign object sensation during use of the armrest 1. In addition, a load during use on the heating wire 5A (see FIG. 9) passed through the upper corner of the base material bulging portion 2C can be reduced.

As illustrated in FIG. 6, the end at the tip drawn from the rear side to the base material back side of the heater base fabric 5 sticks to the base material back side of the armrest base material 2 by the other sticking portion 5F described above. From the end of the heater base fabric 5, a harness 5B electrically connected to the heating wire 5A is routed to extend forward. The harness 5B is electrically connected to a wiring extending from the vehicle side (not illustrated) via a connector 5C electrically connected to the distal end thereof.

To summarize the above, the armrest 1 according to the present embodiment may have the following configuration. In the following description, reference numerals assigned in parentheses correspond to the configurations described in the above embodiment.

That is, the armrest (1) includes: an armrest base material (2) forming a framework along the elbow rest surface (F); a cushioning armrest pad (3) provided on a base material surface of the armrest base material (2); and an armrest cover (4) covering the armrest pad (3) from a pad front side. The armrest base material (2) includes a base material top plate (2A) extending in an armrest front-rear direction along the elbow rest surface (F), a bent-down portion (2B) bent downward from an end of the base material top plate (2A) in the armrest front-rear direction, and a base material bulging portion (2C) bulging from an end of a bent tip of the bent-down portion (2B) toward a base material front side.

The armrest pad (3) is provided across the base material top plate (2A) and the bent-down portion (2B) to form a surface shape continuous with the base material bulging portion (2C). The armrest cover (4) is covered across the armrest pad (3) and the base material bulging portion (2C).

According to the above configuration, the armrest pad (3) is bent across the base material top plate (2A) and the bent-down portion (2B) of the armrest base material (2). Further, the end facing the base material bulging portion (2C) of the armrest pad (3) is arranged to form a surface shape continuous with the base material bulging portion (2C). Accordingly, the pressing force due to the stretching of the armrest cover 4 is strongly applied to the R-shaped portion R of the armrest pad 3, and thus is less likely to concentrate on the upper edge of the end. As a result, a highlight line, which is a cause of deterioration in appearance, is less likely to appear on the cover surface, and the shape of the cover surface is less likely to collapse.

In addition, the armrest (1) further includes a planar heater base fabric (5) including a heating wire (5A), the planar heater base fabric (5) being sandwiched between the armrest pad (3) and the armrest cover (4). The heater base fabric (5) has a first sticking portion (5D) passed between the base material bulging portion (2C) and the armrest cover (4) and sticking to the base material bulging portion (2C). The heater base fabric (5) sticks to the base material bulging portion (2C) in this manner, thereby preventing the heater base fabric (5) from being pulled out to the front side by the repulsive force of the armrest pad (3).

Further, the bent-down portion (2B) is bent downward from a rear end of the base material top plate (2A). The heater base fabric (5) further includes a second sticking portion (5E) passed through the base material back side and sticking to the armrest base material (2) to wrap a front end of the base material top plate (2A). According to the above configuration, the front and rear portions of the heater base fabric (5) across the armrest pad (3) stick to the armrest base material (2). This can more appropriately prevent the heater base fabric (5) from being pulled out to the front side by the repulsive force of the armrest pad (3).

Further, the base material bulging portion (2C) is provided at a position lower than the base material top plate (2A). According to the above configuration, even when a load is applied to the vicinity of the bent-down portion (2B) from above due to an elbow resting thereon, the upper corner of the end facing the armrest pad (3) of the base material bulging portion (2C) is less likely to come into contact with the elbow. this can reduce the foreign object sensation during use of the armrest 1. In addition, if a wiring such as the heating wire (5A) is passed through the upper corner of the base material bulging portion (2C), a load applied to the wiring during use can be reduced.

Further, the heating wire (5A) includes a slack portion (A1) bent to form slack along a planar direction of the heater base fabric (5) in a region across the armrest pad (3) and the base material bulging portion (2C). According to the above configuration, it is possible to prevent the heating wire (5A) from tightening when a load is applied to the elbow rest surface (F) from above due to an elbow resting thereon. This can prevent an excessive load from being applied to the heating wire (5A) such that the heating wire is strongly pressed against the upper corner of the base material bulging portion (2C).

### Other Embodiments

The embodiments according to the present disclosure have been described with reference to one embodiment, whereas the present disclosure can be implemented in various forms other than the above embodiment.

1. Instead of a door armrest, the armrest of the present disclosure may be configured as a so-called seat armrest attached to a side portion of a seat. The armrest may be attached to a top plate of a console box or may be attached to an interior trim other than a door trim, such as a deck side trim.

The armrest may be applied to a vehicle other than an automobile, such as a train, an aircraft, or a ship. Instead of seats provided for vehicles, the armrest may be applied to seats not provided for vehicles such as provided in various facilities such as sports facilities, theaters, concert halls, and event venues, or massage seats, as well as interior trims that are installed alongside seats.

2. The armrest cover may be made of natural leather or fabric instead of synthetic leather. The first sticking portion or the second sticking portion for sticking the heater base fabric to the armrest base material may be made from sticking means other than a double-sided tape, such as a hook-and-loop fastener or an adhesive.

3. The heating wire may be attached to the heater base fabric by a method other than sewing, such as welding or adhesion. The heating wire may be attached to the front surface instead of the back surface of the heater base fabric, or may be attached to both the front and back surfaces. In addition, the heater base fabric may be constituted by two layers including front and back, and the heating wire may be attached in a manner of being sandwiched between the two layers of heater base fabrics.

4. The bent-down portion of the armrest base material may be formed at the front end instead of the rear end of the base material top plate. The bent-down portion may be bent downward instead of being curved downward from the end of the base material top plate in the armrest front-rear direction.

5. In the above embodiment, the felt is integrally provided on the base material surface of the base material bulging portion, and the first sticking portion of the heater base fabric indirectly sticks to the base material bulging portion via the felt. Alternatively, the first sticking portion may directly stick to the base material bulging portion, without providing a felt.

6. In the above embodiment, the heater base fabric is passed through the base material back side to wrap the front end of the base material top plate, and sticks to the armrest base material by the second sticking portion. However, the heater base fabric may stick to the base material front side rather than the base material back side of the front end of the base material top plate. Alternatively, the heater base fabric may stick to both the base material front side and the base material back side of the front end of the base material top plate.

What is claimed is:

1. An armrest having an elbow rest surface, comprising:
an armrest base material forming a framework along the elbow rest surface;
a cushioning armrest pad provided on a base material surface of the armrest base material; and
an armrest cover covering the armrest pad from a pad front side, wherein
the armrest base material includes
a base material top plate extending in an armrest front-rear direction along the elbow rest surface,
a bent-down portion bent downward from an end of the base material top plate in the armrest front-rear direction, and
a base material bulging portion bulging from an end of a bent tip of the bent-down portion toward a base material front side,
the armrest pad is provided across the base material top plate and the bent-down portion,
the base material bulging portion bilges such that a surface of the base material bulging portion forms a surface shape continuous with the armrest pad, and
the armrest cover is covered across the armrest pad and the base material bulging portion.

2. The armrest according to claim 1, further comprising:
a planar heater base fabric including a heating wire, the heater base fabric being sandwiched between the armrest pad and the armrest cover, wherein
the heater base fabric has a first sticking portion passed between the base material bulging portion and the armrest cover and sticking to the base material bulging portion.

3. The armrest according to claim 2, wherein
the bent-down portion is bent downward from a rear end of the base material top plate, and
the heater base fabric further includes a second sticking portion passed through the base material back side and sticking to the armrest base material to wrap a front end of the base material top plate.

4. The armrest according to claim 1, wherein
the base material bulging portion is provided at a position lower than the base material top plate.

5. The armrest according to claim 2, wherein
the base material bulging portion is provided at a position lower than the base material top plate.

6. The armrest according to claim 3, wherein
the base material bulging portion is provided at a position lower than the base material top plate.

7. The armrest according to claim 2, wherein
the heating wire includes a slack portion bent to form a slack along a planar direction of the heater base fabric in a region across the armrest pad and the base material bulging portion.

8. The armrest according to claim 3, wherein
the heating wire includes a slack portion bent to form a slack along a planar direction of the heater base fabric in a region across the armrest pad and the base material bulging portion.
